(19) United States
(12) Patent Application Publication
(10) Pub. No.: US 2020/0002021 A1
(43) Pub. Date: Jan. 2, 2020

(54) AIRCRAFT, AND AIRCRAFT MAINTENANCE METHOD

(71) Applicant: Mitsubishi Aircraft Corporation, Aichi (JP)

(72) Inventor: Nobuhide Hara, Tokyo (JP)

(73) Assignee: Mitsubishi Aircraft Corporation, Aichi (JP)

(21) Appl. No.: 16/456,594

(22) Filed: Jun. 28, 2019

(30) Foreign Application Priority Data
Jun. 28, 2018 (JP) 2018-122747

(51) Int. Cl. B64D 33/04; B64F 5/40

(52) U.S. Cl. CPC B64D 33/04; B64F 5/40

(57) ABSTRACT

High-temperature gas exhausted to outside of an aircraft including exhaust air from an air conditioner is prevented from thermally influencing an airframe. An aircraft includes, in an airframe, an exhaust port configured to exhaust, to outside of the aircraft, high-temperature gas that flows through an exhaust duct provided in an air conditioner and has temperature higher than allowable temperature of GFRP used as a material of a fairing, and a partition as a turning reduction portion configured to reduce a turning component contained in flow of the high-temperature gas before the high-temperature gas is exhausted to the outside of the aircraft.

### BACKGROUND OF THE DISCLOSURE

### Field of the Disclosure

The present disclosure relates to an aircraft subjected to measures against clinging, to a surface of an airframe, of high-temperature gas exhausted to outside of the aircraft such as exhaust air from an air conditioner of the aircraft, and an aircraft maintenance method.

### Description of the Related Art

An air conditioner provided in an aircraft is typically provided in a fuselage lower part and is covered with a belly fairing. Exhaust air from the air conditioner is guided by an exhaust duct to an exhaust port provided in the belly fairing, and is exhausted to outside of the aircraft from the exhaust port. For example, high-temperature exhaust air exceeding 100° C. is exhausted from the exhaust port.

In JP 2009-507179 A, to cope with a high-temperature spot that is formed when the exhaust air from an engine of a rotorcraft abuts on an airframe surface, the exhaust air is exhausted upward so as to be separated from the airframe surface.

The exhaust air exhausted to the outside of the aircraft from the exhaust duct of the air conditioner of the aircraft through the exhaust port is cooled by external air when the aircraft is flying in the sky. The exhaust air exhausted to the outside of the aircraft, however, is not necessarily sufficiently cooled by the external air while the aircraft is parked, is travelling on the ground, or is flying at low altitude.

An object of the present disclosure is to prevent the high-temperature gas exhausted to the outside of the aircraft including the exhaust air from the air conditioner from thermally influencing the airframe.

### SUMMARY OF THE DISCLOSURE

If the exhaust air is ejected from the exhaust duct of the air conditioner toward an out-of-plane direction of a surface of an airframe but flow of the exhaust air is bent outside the aircraft and clings to the surface of the airframe, there is a concern that a member on the surface of the airframe may become overheated.

The inventers of the present disclosure have conceived that a turning component is contained in the exhaust air as a factor causing the exhaust air to be bent and to cling to the surface of the airframe, and have confirmed the containing of the turning component through analysis.

A first aircraft according to the present disclosure conceived based on the above-described new knowledge includes, in an airframe, an exhaust port configured to exhaust, to outside of the aircraft, high-temperature gas that flows through a duct provided in an accessory of the aircraft and has temperature higher than prescribed temperature, and a turning reduction portion configured to reduce a turning component contained in flow of the high-temperature gas before the high-temperature gas is exhausted to the outside of the aircraft.

In the following, preferable requirements for the first aircraft are described.

In the aircraft according to the present disclosure, the turning reduction portion is preferably a partition partitioning a flow path of the high-temperature gas along the flow of the high-temperature gas.

In the aircraft according to the present disclosure, the partition is preferably provided rotationally symmetrically with respect to a cross-section center part of the flow path.

In the aircraft according to the present disclosure, the partition preferably includes a wall having a substantially cross-shaped cross-section.

In the aircraft according to the present disclosure, the turning reduction portion is preferably provided in the duct.

The aircraft according to the present disclosure preferably further includes a cylinder configured to form a flow path of the high-temperature gas together with the duct and the exhaust port, and the turning reduction portion is preferably provided in the cylinder.

In the above-described configuration, the duct and the cylinder are preferably connected to each other by a connection member.

In the aircraft according to the present disclosure, the airframe or the duct preferably includes a separation prevention portion configured to catch the turning reduction portion from the exhaust port side.

The aircraft according to the present disclosure preferably includes a heat insulating member configured to cover a surface of the airframe in a region adjacent to the exhaust port, and an attachment portion configured to detachably attach the heat insulating member to the airframe.

Next, a configuration of a second aircraft according to the present disclosure is described.

The second aircraft according to the present disclosure includes an exhaust port configured to exhaust, to outside of the aircraft, high-temperature gas that flows through a duct provided in an accessory of the aircraft and has temperature higher than prescribed temperature, a heat insulating member configured to cover a surface of an airframe of the aircraft in a region adjacent to the exhaust port, and an attachment portion configured to detachably attach the heat insulating member to the airframe.

In the following, preferable requirements for the second aircraft are described.

In the second aircraft according to the present disclosure, the attachment portion and the heat insulating member are preferably attachable to each other by a permanent magnet.

In the second aircraft according to the present disclosure, the attachment portion is preferably provided flat along the surface of the airframe.

In the second aircraft according to the present disclosure, the heat insulating member preferably includes a heat insulating sheet member and a support wall that is provided on the sheet member and prevents the high-temperature gas from flowing into a gap between the sheet member and the surface of the airframe.

In the following, preferable requirements common to the first aircraft and the second aircraft are described.

In the aircraft according to the present disclosure, a region around the exhaust port in the airframe is preferably made of fiber-reinforced plastic containing reinforcing fibers.

In the aircraft according to the present disclosure, the accessory is preferably an air conditioner performing air conditioning inside the aircraft.

In the aircraft according to the present disclosure, the accessory is preferably disposed at a bottom part of a fuselage that is covered with a fairing forming the surface of the airframe, and the exhaust port is preferably provided in the fairing.

Further, the disclosure for the second aircraft can be developed to a method of maintaining an aircraft.

The present disclosure relates to a method of maintaining an aircraft that includes an exhaust port in an airframe. The exhaust port is configured to exhaust, to outside of the aircraft, high-temperature gas that flows through a duct provided in an accessory of the aircraft and has temperature higher than prescribed temperature. The method includes performing maintenance accompanied by actuation of the accessory while a heat insulating member is attached to the airframe to cover a surface of the airframe in a region adjacent to the exhaust port.

According to the present disclosure relating to the first aircraft, the turning component contained in the exhaust air exhausted to the outside of the aircraft from the duct of the accessory is reduced by the turning reduction portion provided on the airframe before the exhaust air is exhausted to the outside of the aircraft. This makes it possible to prevent the exhaust air exhausted to the outside of the aircraft from the exhaust port from being bent by the turning component contained in the flow of the exhaust air, and to exhaust the exhaust air in a direction separating from the surface of the airframe. In other words, it is possible to avoid the exhaust air from clinging to the surface of the airframe. This makes it possible to prevent thermal influence by the heat of the exhaust air exhausted to the outside of the aircraft from being applied to the airframe.

The disclosure relating to the first aircraft including the turning reduction portion is particularly effective to a case where the temperature of the high-temperature gas exhausted from the exhaust port is difficult to be sufficiently reduced even through contact with atmospheric air around the airframe because of high temperature of the atmospheric air around the airframe, while the aircraft is subjected to maintenance, is parked, or is travelling on the ground, or in takeoff or landing.

Further, according to the present disclosure relating to the second aircraft and the present disclosure relating to the method of maintaining the aircraft, when maintenance accompanied by actuation of the accessory is performed while the heat insulating material is attached to the airframe, the heat insulating member covering the surface of the airframe in a range adjacent to the exhaust port can prevent the heat of the exhaust air from propagating to the airframe even in a case where the temperature of the high-temperature gas exhausted to the outside of the aircraft is largely increased like a case where engine output is maximized during the maintenance. This also makes it possible to prevent thermal influence by the heat of the exhaust air exhausted to the outside of the aircraft from being applied to the airframe.

### BRIEF DESCRIPTION OF THE DRAWINGS

FIG. 1A is a diagram schematically illustrating an aircraft including an air conditioner, and FIG. 1B is a schematic diagram illustrating, together with the air conditioner, a countermeasure structure against clinging of high-temperature gas (exhaust air from air conditioner) to an airframe according to a first embodiment;

FIG. 2 is a schematic diagram illustrating the air conditioner illustrated in FIG. 1B, a fan and an exhaust duct provided in the air conditioner, and the countermeasure structure against clinging of the high-temperature gas;

FIG. 3A is a diagram illustrating the exhaust duct of the air conditioner and the airframe (fairing) as viewed from rear side, and FIG. 3B is a diagram illustrating the exhaust duct and an exhaust port of the fairing as viewed from bottom side;

FIG. 4A is a cross-sectional view taken along a line IVa-IVa of FIG. 2 and illustrates a partition (turning reduction portion) of the exhaust duct, FIG. 4B is a side view illustrating a partition member of the partition according to another mode, and FIG. 4C is a cross-sectional view taken along a line IVc-IVc of FIG. 4B;

FIGS. 5A to 5D are cross-sectional views each illustrating a modification of the turning reduction portion;

FIG. 6A is a diagram illustrating an example in which a partition member is provided on downstream side of the exhaust duct, and FIG. 6B is a diagram illustrating an example in which a partition member is provided on upstream side of the exhaust duct;

FIGS. 7A and 7B are schematic diagrams each illustrating a countermeasure structure against clinging of high-temperature gas according to a modification of the first embodiment;

FIG. 8 is a schematic view illustrating a countermeasure structure against clinging of high-temperature gas according to another modification of the first embodiment; and

FIG. 9A is a schematic diagram illustrating a countermeasure structure against clinging of high-temperature gas provided on starboard side of an aircraft according to a second embodiment as viewed from bottom side, and FIG. 9B is a cross-sectional view taken along a line IXb-IXb of FIG. 9A and illustrates a fairing, a heat insulating member covering a range of the fairing on the starboard side, and a heat insulating member covering a range of the fairing on port side as viewed from rear side.

### DETAILED DESCRIPTION OF THE PREFERRED EMBODIMENTS

Some embodiments of the present disclosure are described below with reference to accompanying drawings.

### First Embodiment

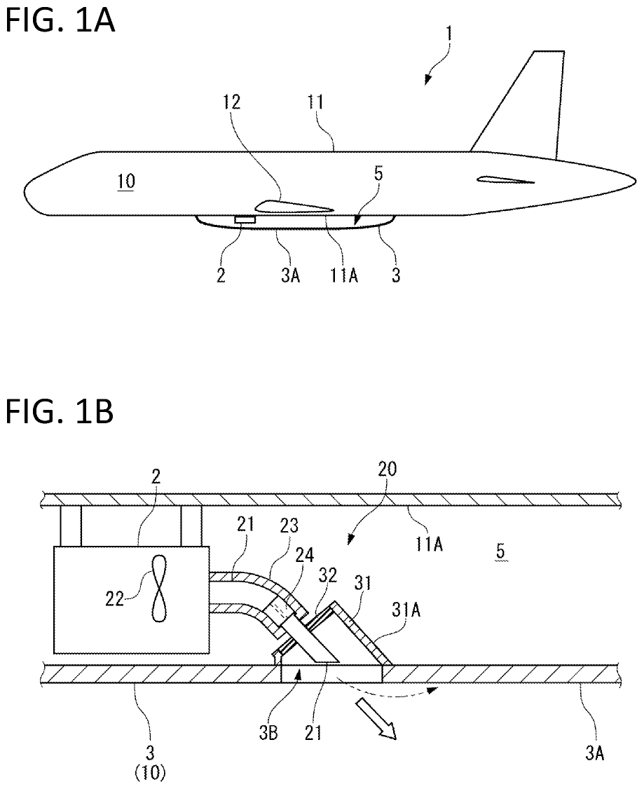

An aircraft 1 illustrated in FIG. 1A includes an airframe 10 and various accessories mounted on the airframe 10. The airframe 10 includes a fuselage 11, a main wing 12, a fairing 3 (belly fairing) covering a bottom part 11A of the fuselage 11.

A plurality of accessories is provided on the fuselage bottom part 11A. As one of the accessories, there is an air conditioner 2 configuring an air conditioning system of the aircraft. The air conditioning system bears the entire air conditioning functions including pressurization inside the aircraft, ventilation, and air cooling/heating.

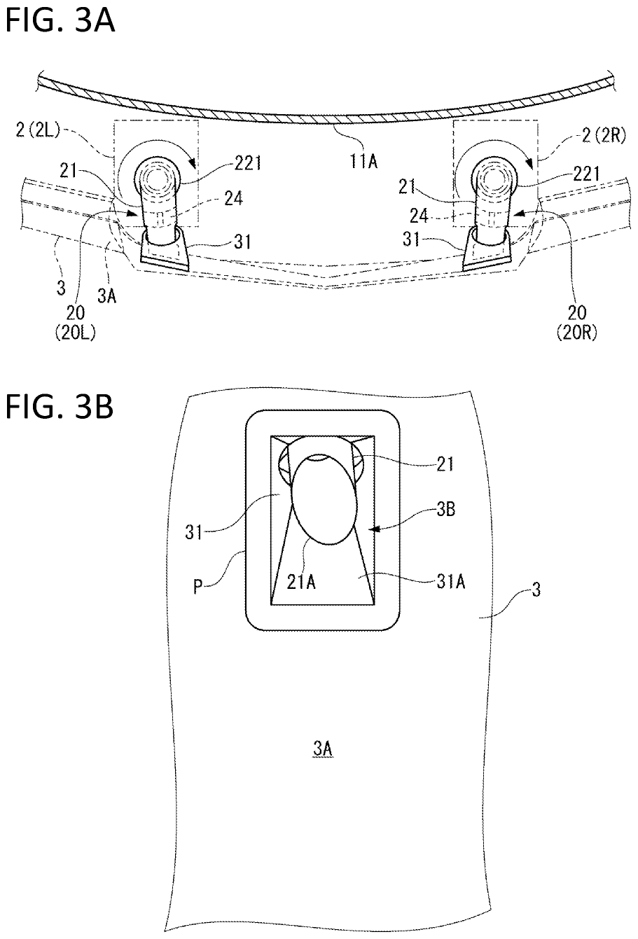

Two air conditioners 2 are provided in order to secure redundancy. One of the air conditioners 2 is provided on left side of the fuselage bottom part 11A, and the other air conditioner 2 is provided on right side of the fuselage bottom part 11A (see FIG. 3A).

The air conditioning system supplies air-conditioning air obtained from the air conditioners 2, to a pressurized section such as a cabin through unillustrated pipes. A part of the air-conditioning air is exhausted to an inside of the fairing 3 from the pressurized section through an unillustrated pressure regulating valve provided on the fuselage bottom part 11A. Pressure inside the fairing 3 is higher than pressure outside the fairing 3 (outside aircraft) due to pressure of the air-conditioning air exhausted through the pressure regulating valve.

The fairing 3 covers the various accessories including the air conditioners 2 provided on the fuselage bottom part 11A. The fairing 3 can be made of fiber-reinforced plastic containing glass fibers, carbon fibers, or the like as reinforcing fibers, or a metal material such as an aluminum alloy.

The fairing 3 according to the present embodiment is made of glass fiber reinforced plastic (GFRP) in order to reduce its weight.

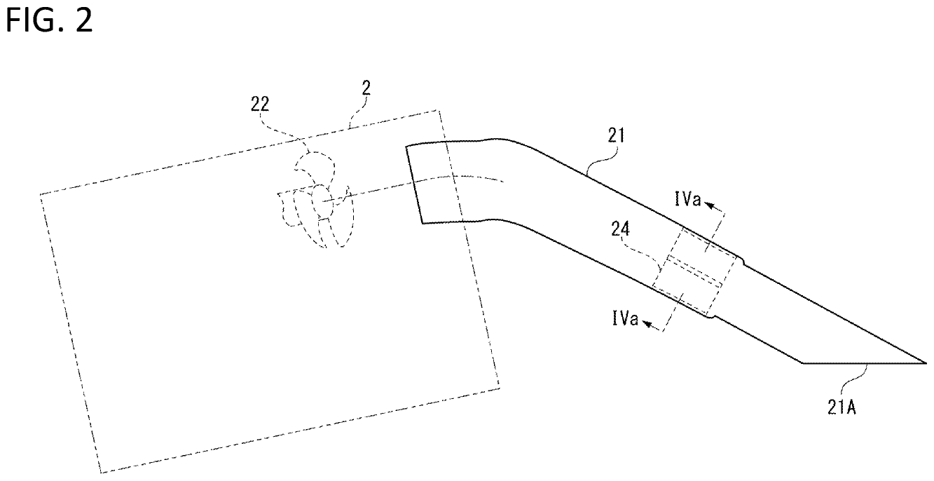

As illustrated in FIG. 1B and FIG. 2, each of the air conditioners 2 includes an exhaust duct 21 through which the exhaust air (high-temperature gas) flows. Temperature of the exhaust air flowing through the exhaust duct 21 may become higher than allowable temperature (prescribed temperature) of a surface 3A of the fairing 3. The temperature of the exhaust air flowing through the exhaust duct 21 is, for example, 100° C. to 150° C. The allowable temperature of the fairing 3 is significantly lower than allowable temperature of stainless steel that is typically used for a member coming into contact with high-temperature gas.

Although specific illustration is omitted, each of the air conditioners 2 includes a turbine, a compressor, a heat exchanger, a capacitor, an intake port for bleed air from an engine or an auxiliary power unit and for an external air, pipes, a fan 22 (FIG. 2), and the like.

The fan 22 according to the present embodiment is a propeller fan, and is disposed inside a cylindrical casing 221 (FIG. 3A). An arrow illustrated in FIG. 3A indicates a direction in which the fan 22 rotates.

The exhaust air from one air conditioner 2 is guided to an exhaust port 3B provided in the fairing 3 through the exhaust duct 21, and is ejected to the outside of the aircraft through the exhaust port 3B. If the flow of the exhaust air flowing through the exhaust duct 21 contains a turning component, and a route of the flow of the exhaust air is bent backward as illustrated by an alternate long and two short dashes line in FIG. 1B due to the turning component, the exhaust air may abut on the surface 3A of the fairing 3 and may flow so as to cling to the surface 3A of the fairing 3.

The flow of the exhaust air exhausted from the exhaust port 3B to the outside of the aircraft in a manner of being bent outside the aircraft and clinging to the fairing surface 3A is referred to as “clinging” of the exhaust air to the airframe 10 (fairing 3). It is necessary to prevent heat of the exhaust air from thermally influencing the fairing 3 due to such clinging of the exhaust air.

The flow of the exhaust air exhausted from the exhaust duct 21 contains the turning component provided from rotation of the fan 22. Note that, even in a case where the fan 22 is not provided, the flow of the exhaust air may contain the turning component due to interference of the exhaust air with any member.

The aircraft 1 includes a countermeasure structure 20 (FIG. 1B) against clinging of high-temperature gas. The countermeasure structure can cope with the clinging, to the fairing surface 3A, of the exhaust air exhausted from the exhaust port 3B to the outside of the aircraft.

In the present embodiment, the flow of the exhaust air exhausted from the exhaust duct 21 contains the turning component provided from rotation of the fan 22.

The countermeasure structure 20 against clinging of high-temperature gas includes the exhaust duct 21, the exhaust port 3B from which the exhaust air flowing through the exhaust duct 21 is exhausted to the outside of the aircraft, and a partition 24 as a turning reduction portion reducing the turning component in the exhaust air that is a factor of clinging of the exhaust air.

In the countermeasure structure 20 against clinging of high-temperature gas illustrated in FIG. 1B, the partition 24 provided in the exhaust duct 21 reduces the turning component contained in the exhaust air before the exhaust air is exhausted from the exhaust port 3B to the outside of the aircraft.

As illustrated in FIG. 3A, the countermeasure structure 20 against clinging of high-temperature gas is preferably provided on each of the port side (left side in figure) and the starboard side (right side in figure). A clinging countermeasure structure 20L on the port side prevents clinging of the exhaust air exhausted from the exhaust duct 21 of the air conditioner 2 provided on the left side of the fuselage bottom part 11A to the outside of the aircraft. A clinging countermeasure structure 20R provided on the right side of the fuselage bottom part 11A prevents clinging of the exhaust air exhausted from the exhaust duct 21 of the air conditioner 2 on the right side to the outside of the aircraft.

As illustrated in FIG. 2, the exhaust duct 21 is drawn backward from a position facing the fan 22 and is bent downward, and extends up to a vicinity of the exhaust port 3B (FIG. 1B). The exhaust duct 21 according to the present embodiment has a circular cross-section, and an opening at a lower end 21A has an elliptical shape (FIG. 3B). In the exhaust duct 21 according to the present embodiment, lower side is smaller in diameter than upper side; however, the configuration is not limited thereto, and the exhaust duct 21 has a constant diameter from an upper end to the lower end.

The exhaust duct 21 is made of a metal material such as stainless steel. In particular, CRES (Corrosion REsistant Steel) is preferable.

As illustrated in FIG. 1B, an outer peripheral part of the exhaust duct 21 is preferably covered with a heat insulating material 23 in order to suppress temperature rise of a space 5 inside the fairing 3.

As illustrated in FIG. 1B and FIGS. 3A and 3B, the lower end 21A side of the exhaust duct 21 is preferably supported by a support 31 provided around the exhaust port 3B of the fairing 3.

The support 31 has a wall 31A that stands on the fairing 3 on rear side and surrounds the outer peripheral part on the lower end 21A side of the exhaust duct 21. The lower end 21A side of the exhaust duct 21 is disposed in a space inside the wall 31A.

The support 31 is also made of a metal material such as stainless steel as with the exhaust duct 21.

As illustrated in FIG. 1B, an annular elastic body 32 that supports the outer peripheral part of the exhaust duct 21 is provided on an upper end part of the support 31.

The exhaust port 3B (FIG. 1B and FIG. 3B) is provided so as to penetrate through the fairing 3 in a thickness direction over a range including a projection area of the lower end 21A of the exhaust duct 21. As illustrated in FIG. 3B, the exhaust port 3B according to the present embodiment has a substantially rectangular shape in a planar view. The shape of the exhaust port 3B can be determined to an appropriate shape such as a circular shape and an oval shape.

A member applying resistance to the flow of the exhaust air from the exhaust duct 21 is not provided inside the exhaust port 3B according to the present embodiment. Therefore, the exhaust port 3B can exhaust the exhaust air to the outside of the aircraft without lowering the pressure of the flow of the exhaust air flowing from the exhaust duct 21.

To facilitate maintenance of the exhaust duct 21, a region of the fairing 3 corresponding to the exhaust port 3B and the support 31 is preferably configured as an access panel P that is detachable from a main body of the fairing 3 as illustrated in FIG. 3B. The access panel P is detached to separate the support 31 from the exhaust duct 21.

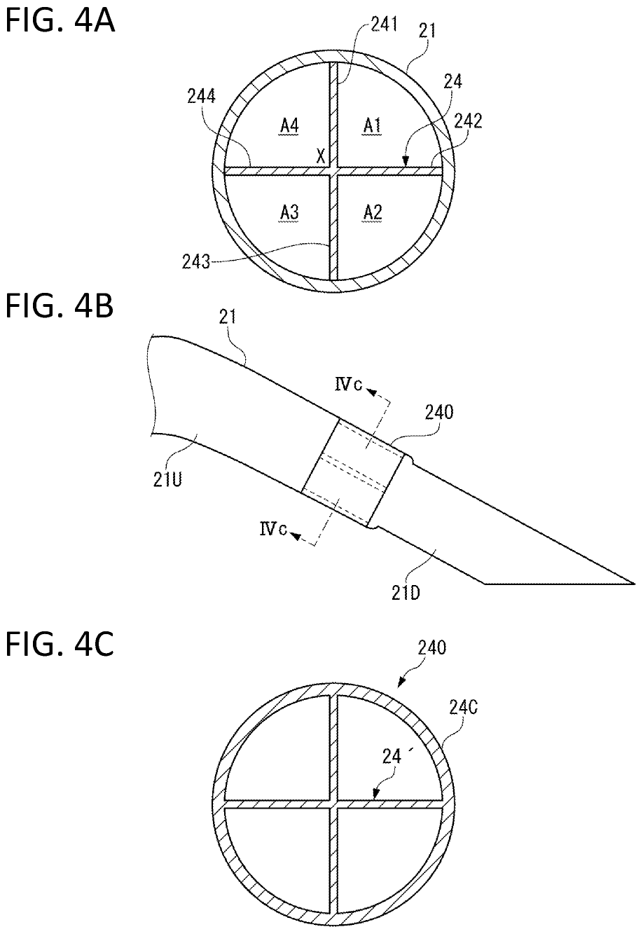

The partition 24 (FIG. 1B, FIG. 2, and FIG. 4A) functions as the turning reduction portion that reduces the turning component contained in the flow of the exhaust air flowing in the exhaust duct 21 through the fan 22 (FIG. 2).

FIG. 4A illustrates the partition 24 provided inside the exhaust duct 21.

As illustrated in FIG. 4A, the partition 24 divides a flow path of the exhaust air inside the exhaust duct 21 into a plurality of sections A1 to A4 along the flow of the exhaust air. As illustrated in FIG. 4A, the partition 24 includes four plate walls 241 to 244 that are disposed from a cross-section center part X of the flow path of the exhaust air to an inner wall of the exhaust duct 21, along a radial direction of the exhaust duct 21. The walls 241 to 244 form a cross-shaped cross-sectional surface, and are continuous along an axis direction of the exhaust duct 21. To reduce the turning component of the exhaust air and to symmetrically rectify the exhaust air relative to the cross-section center of the flow, the walls 241 to 244 are preferably disposed rotationally symmetrically with respect to the cross-section center part X.

The walls 241 to 244 interfere the turning component of the exhaust air while the exhaust air flowing through the exhaust duct 21 flows through the sections A1 to A4 formed inside the exhaust duct 21 by the partition 24, which reduces the turning component. Reduction of the turning component makes it possible to prevent the high-temperature exhaust air from clinging to the outer surface of the airframe and to avoid thermal influence of the exhaust air on the airframe.

The partition 24 can be made of an appropriate metal material such as stainless steel and titanium in consideration of heat resistance, corrosion resistance, and the like. Titanium is suitable for weight reduction.

The walls 241 to 244 of the partition 24 may be integrally configured or configured separately from one another. In a case where the walls 241 to 244 are configured separately from one another, the walls 241 to 244 can be integrated by an appropriate method such as fastening, welding, and brazing.

Further, the partition 24 can be joined to an inner wall 21W of the exhaust duct 21 by an appropriate method such as fastening, welding, and brazing.

FIG. 4B illustrates a partition member 240 that configures a part of the exhaust duct 21 as another form of the partition. The exhaust duct 21 includes an upstream-side duct portion 21U, a downstream-side duct portion 21D, and the partition member 240 disposed between the duct portions 21U and 21D. A continuous exhaust air flow path is formed inside the duct portion 21U, the partition member 240, and the duct portion 21D.

As illustrated in FIG. 4C, the partition member 240 includes a partition portion 24′ having a form similar to the form illustrated in FIG. 4A, and a peripheral wall 24C surrounding the partition portion 24′. The partition portion 24′ and the peripheral wall 24C may be integrally configured as illustrated in FIG. 4C, or the partition portion 24′ and the peripheral wall 24C that are configured separately from each other may be integrated, though illustration is omitted.

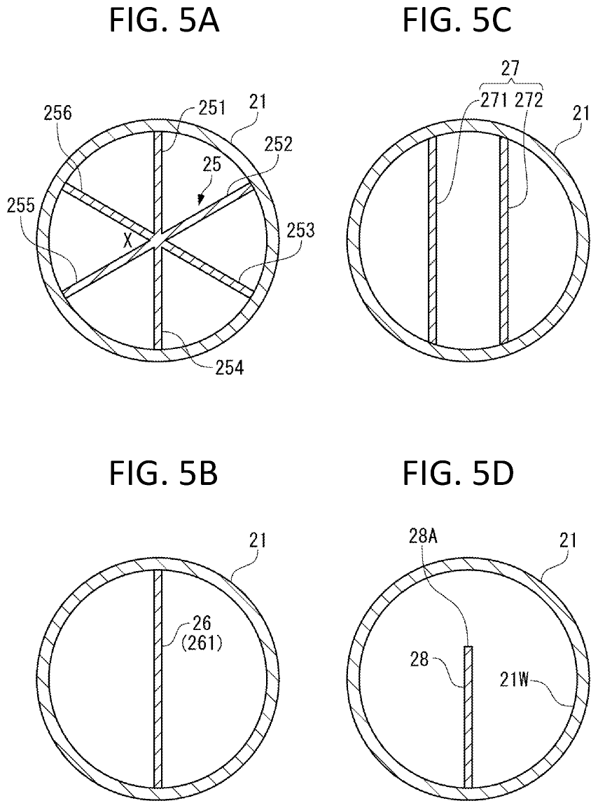

The form of the wall of the partition 24 is not limited to the cross-shaped cross-section, and may be any of forms as illustrated in FIGS. 5A to 5C. In an example illustrated in FIG. 5A, the flow path of the exhaust air is divided into six equal sections by walls 251 to 256 of a partition 25. A partition 26 illustrated in FIG. 5B includes one wall 261 disposed in a diameter direction of the exhaust duct 21, and the flow path of the exhaust air is divided into two equal sections by the wall 261. In an example illustrated in FIG. 5C, a partition 27 includes two walls 271 and 272 that are disposed in parallel with each other inside the exhaust duct 21.

FIG. 5D illustrates a wall 28 that projects from the inner wall 21W of the exhaust duct 21. A front end 28A of the wall 28 and the inner wall 21W of the exhaust duct 21 have a gap therebetween.

The wall 28 also can interfere and reduce the turning component of the exhaust air flowing through the exhaust duct 21, and accordingly functions as the turning reduction portion.

Note that, as compared with the wall 28, the wall 261 partitioning the flow path as illustrated in FIG. 5B is high in effect of reducing the turning component of the exhaust air.

In addition to the partition 24 according to the present embodiment, any of the partitions 25 to 27 and the wall 28 respectively illustrated in FIGS. 5A to 5D can reduce the turning component of the exhaust air and are sufficiently small in pressure loss applying the exhaust air because any of the partitions 25 to 27 and the wall 28 is provided along the flow of the exhaust air.

In this case, reduction of the range of the flow path of the exhaust air in a circumferential direction contributes to reduction of the turning component. Therefore, as compared with the form illustrated in FIG. 5B or FIG. 5C, the turning reduction portion including the wall radially extending from the cross-section center part X, such as the partition 25 illustrated in FIG. 5A and the partition 24 according to the present embodiment, is advantageous.

Further, if the length of the turning reduction portion such as the partition 24 in the flow direction of the exhaust air is excessively small, it is difficult to achieve the effect of reducing the turning component. In contrast, if the length of the turning reduction portion is excessively large, the pressure of the exhaust air is largely lowered because a contact area with the exhaust air is large.

In consideration of the effect of reducing the turning component and the pressure loss, a diameter D and a length L of the turning reduction portion such as the partition 24 desirably satisfies L/D>1.

As described above, the number, the layout, and the length in the flow direction of the walls configuring the turning reduction portion can be appropriately determined in consideration of the effect of reducing the turning component, the pressure loss of the exhaust air, and a direction in which the turning component is deflected with respect to the cross-section center part X of the flow path of the exhaust air as necessary.

The partition 24 according to the present embodiment can divide the flow path of the exhaust air into the four sections in the circumferential direction with the relatively small contact area to form the sections A1 to A4 that are rotationally symmetrical with respect to the cross-section center part X. This makes it possible to efficiently and stably reduce the turning component of the exhaust air.

Although the turning reduction portion described above is provided in the exhaust duct 21, the turning reduction portion is not necessarily provided in the exhaust duct 21 as long as the turning reduction portion can reduce the turning component of the exhaust air before the exhaust air is exhausted from the exhaust port 3B to the outside of the aircraft.

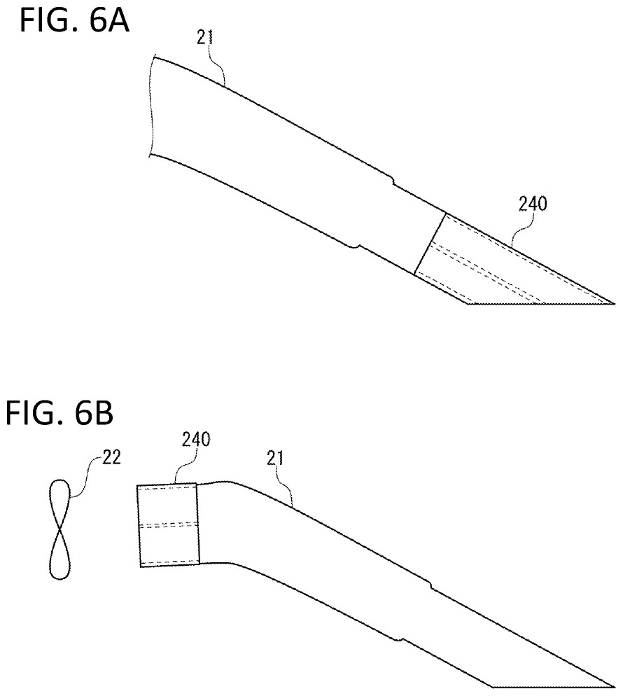

For example, the partition member 240 may be connected to the lower end of the exhaust duct 21 as illustrated in FIG. 6A, or the partition member 240 may be disposed between the fan 22 and the exhaust duct 21 as illustrated in FIG. 6B.

Further, a plurality of turning reduction portions may be provided for the entire flow path of the exhaust air. For example, two partitions 24 may be disposed with an interval in the length direction of the duct 21, inside the exhaust duct 21.

In the aircraft 1 according to the present embodiment described above, the turning component contained in the exhaust air from each of the air conditioners 2 is reduced by the partition 24 as the turning reduction portion provided in the airframe 10 before the exhaust air is exhausted to the outside of the aircraft. As a result, it is possible to prevent the exhaust air exhausted from the exhaust port 3B to the outside of the aircraft from being bent by the turning component contained in the flow of the exhaust air. Accordingly, it is possible to exhaust the exhaust air in a direction away from the fairing surface 3A. In other words, it is possible to avoid the exhaust air from clinging to the fairing surface 3A. Therefore, even if the exhaust air of the temperature higher than the allowable temperature of the fairing 3 is exhausted to the outside of the aircraft, it is possible to prevent the thermal influence by the heat of the exhaust air from being applied to the fairing 3, namely, to prevent deterioration (for example, deterioration in bearing force and strength) of characteristics based on the material of the fairing 3.

It is also considered to prevent clinging of the exhaust air by rectifying the exhaust air containing the turning component by a louver or the like disposed in the exhaust port 3B. The louver includes a plurality of blades guiding the exhaust air ejected from the lower end of the exhaust duct 21 backward. Even when only the louver is used without using the turning reduction portion such as the partition 24, it is difficult to sufficiently reduce the turning component of the exhaust air, and the pressure loss of the exhaust air is increased by resistance of the blades of the louver.

In contrast, the turning reduction portion such as the partition 24 according to the present embodiment that is disposed along the flow of the exhaust air can sufficiently reduce the turning component contained in the exhaust air while suppressing pressure loss of the exhaust air.

Note that the exhaust air in which the turning component has been reduced by the turning reduction portion may be supplementarily rectified by a rectification member such as a louver, as long as the rectification member does not excessively lower the pressure of the exhaust air.

The turning reduction portion such as the partition 24 is particularly effective to a case where the temperature of the exhaust air exhausted from the exhaust port 3B is difficult to be sufficiently reduced even through contact with atmospheric air around the fairing 3 because of high temperature of the atmospheric air around the fairing 3 during maintenance, while the aircraft 1 is parked or is travelling on the ground or when the aircraft 1 takes off or lands before and after flight, on the premise that the air conditioners 2 are actuated. When the aircraft 1 is flying in the sky, the exhaust air is cooled to temperature sufficiently lower than the allowable temperature of the fairing 3 by cold external air at a high altitude immediately after the exhaust air is exhausted from the exhaust port 3B to the outside of the aircraft 1, depending on temperature of the exhaust air, a flight altitude, insolation, climate, and the like. Therefore, even if the exhaust air from the exhaust duct 21 clings to the fairing surface 3A, the exhaust air hardly thermally influences the fairing 3.

While the aircraft is parked, is travelling on the ground, or is flying at an altitude close to the ground in takeoff or landing, however, the exhaust air exhausted from the exhaust port 3B to the outside of the aircraft is not necessarily sufficiently cooled by the ambient air because of heat radiation from the ground. Therefore, it is significant that the turning component of the exhaust air is reduced by the turning reduction portion provided in the airframe 10 to stably exhaust the exhaust air in a direction separating from the airframe 10 while preventing the exhaust air from clinging to the surface of the airframe. For the aircraft 1 that is intended to travel to various places including an intense-heat region, it is significantly important to cope with a severe thermal condition.

As further countermeasures against clinging of high-temperature exhaust air to the airframe 10 in addition to the turning reduction portion such as the partition 24, the temperature of the exhaust air can be reduced with use of the air inside the fairing 3, the temperature of which is lower than the temperature of the exhaust air, before the exhaust air is exhausted to the outside of the aircraft. The air lower in temperature than the exhaust air flowing through the exhaust duct 21 is present in the space 5 inside the fairing 3.

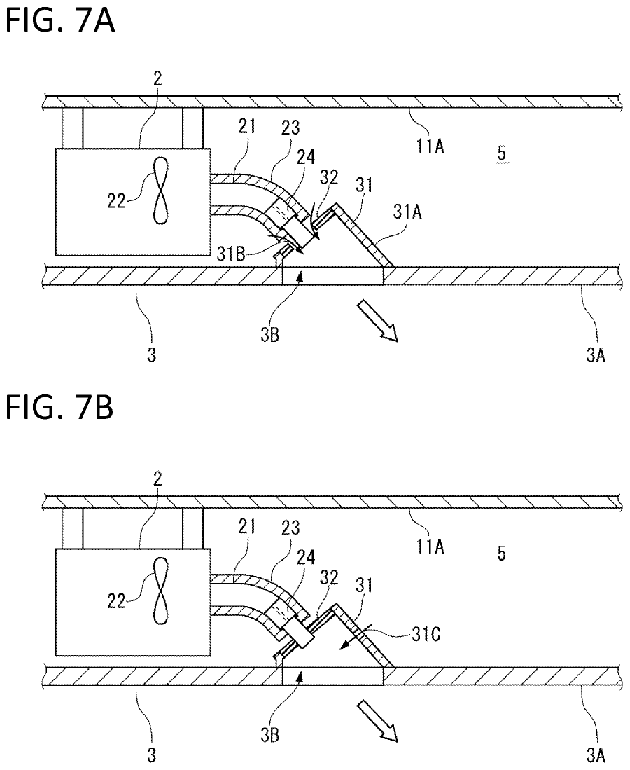

Therefore, as illustrated in FIG. 7A, an introduction portion 31B for low-temperature air is preferably provided on the support 31 and the length of the exhaust duct 21 is preferably set small so as to eject the exhaust air from the exhaust duct 21 to the inside of the support 31. As a result, the air in the space 5 that is high in pressure than the inside of the support 31 is introduced to the inside of the support 31 through the introduction portion 31B. Since the exhaust duct 21 is covered with the heat insulating material 23, it is possible to maintain the low temperature of the air in the space 5, and to introduce the air lower in temperature than the exhaust air to the inside of the support 31 from the space 5 through the introduction portion 31B.

The exhaust air from the exhaust duct 21 is reduced in temperature by coming into contact with and being mixed with the air lower in temperature than the exhaust air inside the support 31, and the exhaust air reduced in temperature is then exhausted to the outside of the aircraft through the exhaust port 3B. Accordingly, even if the exhaust air comes close to the fairing surface 3A outside the aircraft, it is possible to avoid the thermal influence by the heat of the exhaust air from being applied to the fairing 3.

In an example illustrated in FIG. 7A, the introduction portion 31B corresponds to a gap between an inner peripheral part of the elastic body 32 provided on the upper end of the support 31 and the outer peripheral part of the exhaust duct 21.

In addition, as an example illustrated in FIG. 7B, a hole 31C as an introduction portion may be provided on a wall of the support 31.

### [Modification of First Embodiment]

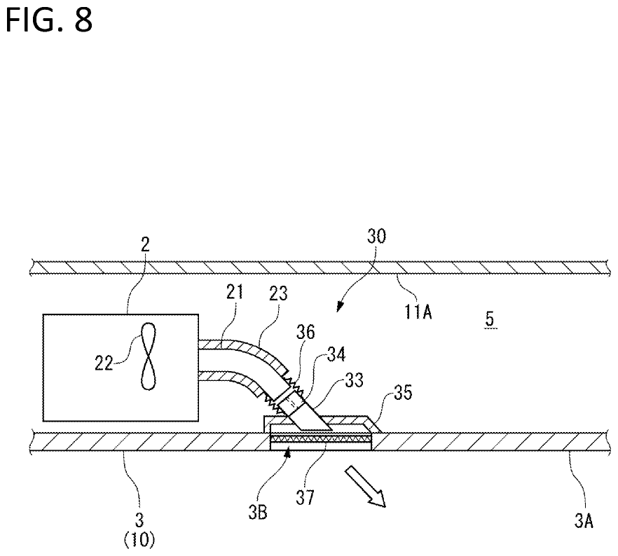

FIG. 8 illustrates a modification of the turning reduction portion according to the first embodiment.

In the above-described first embodiment, the partition (FIG. 1B) is provided in the exhaust duct 21. In contrast, in an example illustrated in FIG. 8, a partition 34 as the turning reduction portion is provided in a cylinder 33 provided on the fairing 3. The cylinder 33 is supported to the fairing 3 by a support 35 fixed to the fairing 3.

A countermeasure structure 30 against clinging of high-temperature gas illustrated in FIG. 8 includes the cylinder 33, the support 35, and the partition 34 in addition to the exhaust duct 21 and the exhaust port 3B.

In the example illustrated in FIG. 8, the partition 34 has a predetermined length from an upper end of the cylinder 33 and extends along the flow of the exhaust air inside the cylinder 33. The configuration is not limited thereto, and the partition 34 may be provided at an appropriate position in the cylinder 33 so as to have an appropriate length in consideration of the effect of reducing the turning component and the pressure loss of the exhaust air. In addition, the specific configuration of the partition 34 including the number, the layout, and the like of walls of the partition 34 can be appropriately determined in a manner similar to the first embodiment.

The cylinder 33 forms the flow path of the exhaust air together with the exhaust duct 21 and the exhaust port 3B. In the example illustrated in FIG. 8, the lower end of the exhaust duct 21 and an upper end of the cylinder 33 are separated from each other; however, the lower end of the exhaust duct 21 may be inserted into the cylinder 33 or the upper end of the cylinder 33 may be inserted into the exhaust duct 21.

The exhaust duct 21 and the cylinder 33 are connected by a joint 36 as a connection member. The joint 36 preferably has a bellows shape in order to sufficiently cope with relative displacement between the cylinder 33 and the exhaust duct 21 caused by expansion/contraction of the cylinder 33 with the change of the external air temperature in flight and vibration. The bellows-shaped joint 36 surrounds an outer peripheral part of the lower end of the exhaust duct 21 and an outer peripheral part of the upper end of the cylinder 33.

The temperature difference between the cylinder 33 close to the external air and the exhaust duct 21 through which the exhaust air flows is increased along with the increase of the flight altitude. At this time, even when the same kind of material is used for the exhaust duct 21 and the cylinder 33, an elongation amount is different between the exhaust duct 21 and the cylinder 33. In such a case, the relative displacement between the exhaust duct 21 and the cylinder 33 can be absorbed by deformation of the joint 36. This makes it possible to secure the flow path of the exhaust air continuous from the exhaust duct 21 to the cylinder 33 without damage of the exhaust duct 21 and the cylinder 33 and without a gap between the exhaust duct 21 and the cylinder 33.

Note that the joint 36 is not necessarily formed in the bellows shape as long as the relative displacement between the exhaust duct 21 and the cylinder 33 is allowed by deformation of the joint 36 and displacement of the joint 36 within assembly tolerances with respect to the exhaust duct 21 and the cylinder 33.

According to the example illustrated in FIG. 8, the partition 34 provided in the cylinder 33 can prevent thermal influence by the heat of the exhaust air from being applied to the fairing 3 as with the first embodiment without necessity of providing the turning reduction portion on the exhaust duct 21.

Also in the example illustrated in FIG. 8, as with the configuration illustrated in FIG. 7A, further countermeasure structure against clinging of high-temperature gas can be adopted, for example, an introduction portion that introduces the air of the space 5 to the inside of the cylinder 33 from the space 5 is provided between the joint 36 and the cylinder 33, and the temperature of the exhaust air is reduced by the low-temperature air introduced to the inside of the cylinder 33.

The fairing 3 preferably includes a wire net-like (mesh-like) member 37 that can catch the partition 34 from the exhaust port 3B side. Even when the wire net-like member 37 is disposed over the entire region of the exhaust port 3B, an opening ratio of the exhaust port 3B is sufficiently high, unlike a louver. Therefore, even if the partition 34 is detached from the cylinder 33, the wire net-like member 37 can catch the partition 34 to prevent the partition 34 from being separated from the airframe 10 without lowering the pressure of the exhaust air.

The wire net-like member 37 is applicable to the countermeasure structure 20 (FIG. 1B) against clinging of high-temperature gas according to the above-described first embodiment. In this case, the wire net-like member 37 that prevents separation of the partition 24 may be provided on the exhaust duct 21.

### Second Embodiment

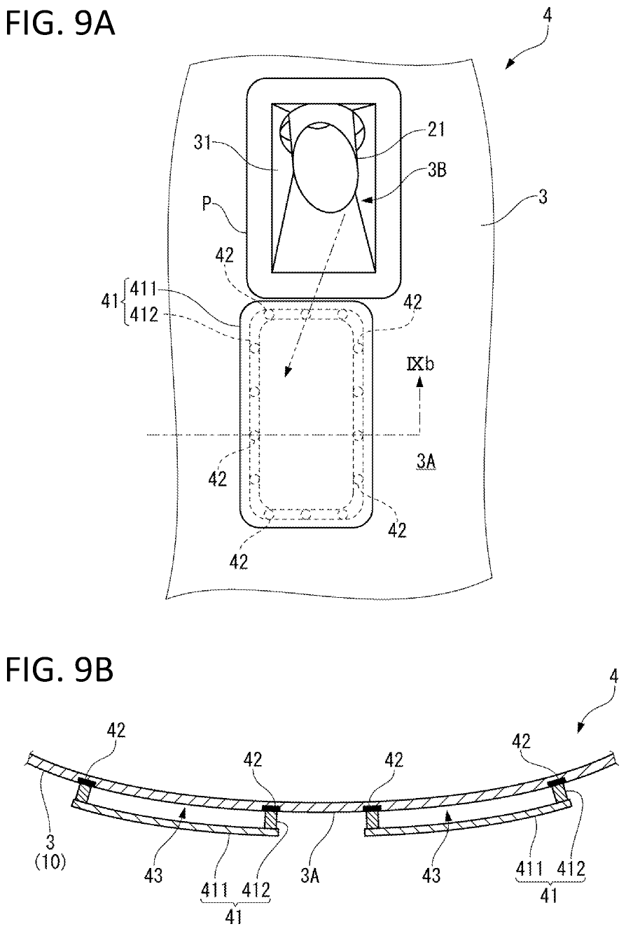

Next, an aircraft 4 according to a second embodiment of the present disclosure is described with reference to FIGS. 9A and 9B. The aircraft 4 takes countermeasures against clinging of high-temperature gas to the airframe 10 from a viewpoint different from the first embodiment. FIGS. 9A and 9B each illustrate a part of the fairing 3 that covers the fuselage bottom part 11A (FIG. 1A) of the aircraft 4.

In the description for the second embodiment, components similar to those in the first embodiment are denoted by the same reference numerals.

The countermeasures against clinging of high-temperature gas according to the second embodiment can be singularly used without using the turning reduction portion according to the first embodiment. The countermeasures against clinging of high-temperature gas according to the second embodiment may be used together with the countermeasures against clinging of high-temperature gas according to the first embodiment. This makes it possible to more reliably avoid thermal influence of the high-temperature exhaust air on the airframe.

The aircraft 4 according to the second embodiment includes a heat insulating member 41 that can cover a surface of a region adjacent to the exhaust port 3B of the fairing 3, and an attachment portion 42 that can detachably attach the heat insulating member 41 to the fairing 3.

Even if the heat insulating member 41 is continuously exposed to the high-temperature exhaust air outside the airframe, the heat insulating member 41 prevents the heat of the exhaust air from propagating to the fairing 3 and maintains the fairing 3 at temperature equal to or lower than the allowable temperature of the fairing 3.

The heat insulating member 41 covers the fairing surface 3A over a predetermined range necessary to protect the fairing 3 from the heat of the exhaust air.

The heat insulating member 41 corresponding to the exhaust port 3B on the starboard side illustrated in FIG. 9A is disposed along the fairing surface 3A over a range where the exhaust air flows near the fairing 3 by considering a direction of the exhaust air illustrated by an alternate long and two short dashes arrow. The direction of the exhaust air described here is merely an example. The range of the fairing surface 3A covered with the heat insulating member 41 can be set based on analysis of the direction of the exhaust air.

The heat insulating member 41 includes a heat insulating sheet 411 that covers the fairing surface 3A, and a support wall 412 that is provided on the heat insulating sheet 411 and is attached to the attachment portion 42.

As the heat insulating sheet 411, a sheet member having a well-known structure with heat insulating property necessary to maintain the fairing 3 at temperature equal to or lower than the allowable temperature can be used. The heat insulating sheet 411 may be a general-purpose heat insulating sheet that is easily available as long as the heat insulating sheet can prevent the high-temperature exhaust air from coming into contact with the airframe. For example, “Damping Aluminum Foam Sheet 4014” available from 3M Company can be used. This product includes polyurethane foam and aluminum backing, and has thermal conductivity of 0.069 W/(m·° C.) and has density of 1.32 kg/m² at a thickness of ¼ inches.

The support wall 412 prevents the exhaust air from flowing into a gap between the heat insulating sheet 411 and the fairing surface 3A over at least a range adjacent to the exhaust port 3B on a peripheral edge part of the heat insulating sheet 411. The support wall 412 can sufficiently suppress heat input to the fairing 3.

The support wall 412 can be formed in an annular shape along the peripheral edge part of the heat insulating sheet 411.

When the support wall 412 provided on the heat insulating sheet 411 is attached to the attachment portion 42 provided on the fairing 3 as illustrated in FIG. 9B, the heat insulating sheet 411 is supported to the fairing 3.

The insulating member 41 is attached to the fairing 3 as necessary at the time of maintenance such as regular inspection of the aircraft 1. The maintenance accompanied by actuation of each of the air conditioners 2 is preferably performed while the heat insulating member 41 is attached to the fairing 3. Even if the flow rate and temperature of bleed air to each of the air conditioners 2 are increased and the temperature of the exhaust air from each of the air conditioners 2 is accordingly largely increased during the maintenance like a case where engine output is maximized in order to obtain the maximum thrust force, the heat insulating member 41 covering the fairing surface 3A in the range adjacent to the exhaust port 3B can avoid the thermal influence from being applied to the fairing 3.

The heat insulating member 41 is detached from the fairing 3 after the maintenance including the work generating the high-temperature exhaust air ends and heat insulation becomes unnecessary. In other words, the heat insulating member 41 is attached to the fairing 3 and is used only when necessary. The heat insulating member 41 is detached from the fairing 3 unless necessary while the aircraft is parked, is travelling on the ground, or is flying.

Accordingly, the heat insulating member 41 is detachably attached to the fairing 3. Further, a gap 43 functioning as a heat insulating layer is preferably provided between the heat insulating member 41 attached to the attachment portion 42 and the fairing surface 3A. When the support wall 412 is formed in an annular shape, the heat insulating layer not accompanied by exchange of the air with outside can be formed inside the support wall 412, the fairing surface 3A, and the heat insulating sheet 411.

To suppress heat transfer by convection inside the heat insulating layer, an appropriate member inhibiting flow of the air is preferably disposed between the heat insulating member 41 and the fairing surface 3A. For example, cushioning paper pieces or cushioning resin pieces for articles may be dispersedly disposed between the heat insulating member 41 and the fairing surface 3A.

Although the heat insulating member 41 can be detachably attached to the fairing 3 by any appropriate method, the heat insulating member 41 is detachably attached to the fairing 3 by a magnet in the present embodiment.

In the present embodiment, the attachment portion 42 provided on the fairing 3 is made of a permanent magnet, and a member made of a magnetic material is provided to the support wall 412 or the support wall 412 itself is made of a magnetic material.

The attachment portion 42 is provided on each of a plurality of positions on the fairing 3 corresponding to the support wall 412 as illustrated by dashed lines in FIG. 9A, for example.

While the heat insulating member 41 is detached from the fairing 3, the attachment portion 42 remains on the fairing 3. To avoid increase of air resistance by the attachment portion 42 while the aircraft is travelling on the ground or is flying, the attachment portion 42 is preferably formed flat along the fairing surface 3A. In the present embodiment, the attachment portion 42 is embedded in the fairing 3. A surface of the attachment portion 42 is continuously flush with the fairing surface 3A (FIG. 9B).

According to the present embodiment, the heat insulating member 41 is attached to the fairing 3 by magnetic attraction force acting between the attachment portion 42 (permanent magnet) and the support wall 412. Therefore, the heat insulating member 41 can be simply and easily attached to or detached from the fairing 3 without using means such as a tape to affix the heat insulating member 41 to the fairing surface 3A besides the heat insulating member 41 and the fairing 3.

The method of attaching the heat insulating member 41 to the fairing 3 is not limited to the method using the magnet. The heat insulating member 41 may be detachably attached to the fairing 3 through, for example, engagement of the support wall 412 of the heat insulating member 41 with a groove of the attachment portion 42.

Other than the above, the configurations described in the above-described embodiments may be selected or appropriately modified without departing from the scope of the present disclosure.

In the present disclosure, the high-temperature gas requiring the countermeasures against clinging to the airframe surface is not limited to the gas exhausted to the outside of the aircraft through the exhaust duct 21 of each of the air conditioners 2, and may be gas exhausted to the outside of the aircraft through a duct provided on the other accessory of the aircraft. Further, the member of the airframe requiring protection from the heat of the high-temperature gas exhausted to the outside of the aircraft is not limited to the belly fairing 3, and may be an appropriate member adjacent to the exhaust port from which the high-temperature gas is exhausted to the outside of the aircraft.

What is claimed is:

1. An aircraft comprising, in an airframe:
an exhaust port configured to exhaust, to outside of the aircraft, high-temperature gas that flows through a duct provided in an accessory of the aircraft and has temperature higher than prescribed temperature; and
a turning reduction portion configured to reduce a turning component contained in flow of the high-temperature gas before the high-temperature gas is exhausted to the outside of the aircraft.

2. The aircraft according to claim 1, wherein the turning reduction portion is a partition partitioning a flow path of the high-temperature gas along the flow of the high-temperature gas.

3. The aircraft according to claim 2, wherein the partition is provided rotationally symmetrically with respect to a cross-section center part of the flow path.

4. The aircraft according to claim 3, wherein the partition includes a wall having a substantially cross-shaped cross-section.

5. The aircraft according to claim 1, wherein the turning reduction portion is provided in the duct.

6. The aircraft according to claim 1, further comprising a cylinder configured to form a flow path of the high-temperature gas together with the duct and the exhaust port, wherein
the turning reduction portion is provided in the cylinder.

7. The aircraft according to claim 6, wherein the duct and the cylinder are connected to each other by a connection member.

8. The aircraft according to claim 1, wherein the airframe or the duct includes a separation prevention portion configured to catch the turning reduction portion from the exhaust port side.

9. The aircraft according to claim 1, further comprising:
a heat insulating member configured to cover a surface of the airframe in a region adjacent to the exhaust port; and
an attachment portion configured to detachably attach the heat insulating member to the airframe.

10. An aircraft comprising:
an exhaust port configured to exhaust, to outside of the aircraft, high-temperature gas that flows through a duct provided in an accessory of the aircraft and has temperature higher than prescribed temperature;
a heat insulating member configured to cover a surface of an airframe of the aircraft in a region adjacent to the exhaust port; and
an attachment portion configured to detachably attach the heat insulating member to the airframe.

11. The aircraft according to claim 10, wherein the attachment portion and the heat insulating member are attachable to each other by a permanent magnet.

12. The aircraft according to claim 10, wherein the attachment portion is provided flat along the surface of the airframe.

13. The aircraft according to claim 10, wherein the heat insulating member includes a heat insulating sheet member and a support wall that is provided on the sheet member and prevents the high-temperature gas from flowing into a gap between the sheet member and the surface of the airframe.

14. The aircraft according to claim 1, wherein a region around the exhaust port in the airframe is made of fiber-reinforced plastic containing reinforcing fibers.

15. The aircraft according to claim 1, wherein the accessory is an air conditioner performing air conditioning inside the aircraft.

16. The aircraft according to claim 1, wherein
the accessory is disposed at a bottom part of a fuselage that is covered with a fairing forming the surface of the airframe, and
the exhaust port is provided in the fairing.

17. A method of maintaining an aircraft that includes an exhaust port in an airframe, the exhaust port being configured to exhaust, to outside of the aircraft, high-temperature gas that flows through a duct provided in an accessory of the aircraft and has temperature higher than prescribed temperature, the method comprising performing maintenance accompanied by actuation of the accessory while a heat insulating member is attached to the airframe to cover a surface of the airframe in a region adjacent to the exhaust port.
